(19) United States
(12) Patent Application Publication
(10) Pub. No.: US 2021/0312191 A1
(43) Pub. Date: Oct. 7, 2021

(54) SYSTEM AND METHOD FOR EFFICIENT PRIVACY PROTECTION FOR SECURITY MONITORING

(71) Applicant: Cherry Labs, Inc., Wilmington, DE (US)

(72) Inventors: Maksim Goncharov, Redwood City, CA (US); Anton Maltsev, Moscow (RU); Stanislav Veretennikov, San Francisco, CA (US); Jiunn Benjamin Heng, Los Altos Hills, CA (US)

(21) Appl. No.: 17/353,210

(22) Filed: Jun. 21, 2021

Related U.S. Application Data
(63) Continuation of application No. PCT/US21/24302, filed on Mar. 26, 2021.
(60) Provisional application No. 63/001,844, filed on Mar. 30, 2020.

(51) Int. Cl. G06K 9/00; G06F 21/62; G06N 3/08; G06K 9/46; G06K 9/62; G06T 7/70

(52) U.S. Cl. CPC G06K 9/00771; G06F 21/6245; G06N 3/08; G06K 9/00362; G06K 9/00335; G06K 9/4604; G06T 2207/10016; G06K 9/627; G06T 7/70; G06T 2207/30196; G06T 2207/30232; G06T 2207/20132; G06K 9/6217

(57) ABSTRACT

A new approach is proposed to support efficient user privacy protection for security monitoring. A set of stick figures depicting a human body of a user is extracted from a set of still images taken over a period of time in a collected video stream at a monitored location. An activity of the user at the monitored location is then recognized based on analysis of the one or more stick figures in each of the one or more still images taken from the video stream over the period of time. In some embodiments, at least a portion of the human body of the user is pixelized to ensure protection of the user's privacy data while still enabling the security monitoring system to effectively perform its security monitoring functions. Additionally, the captured privacy data of the user is securely stored at a local site to further ensure privacy of the user.

### CROSS-REFERENCE TO RELATED APPLICATIONS

This application is a continuation application of United States Patent Application No. PCT/US21/24302, filed Mar. 26, 2021, entitled “System and Method for Efficient Privacy Protection for Security Monitoring,” which claims the benefit of U.S. Provisional Patent Application No. 63/001,844, filed Mar. 30, 2020. Both of which are incorporated herein in their entireties by reference.

### BACKGROUND

A variety of security, monitoring and control systems equipped with a plurality of cameras and/or sensors have been used to detect various threats such as intrusions, fire, smoke, flood, etc. at a monitored location (e.g., home or office). For a non-limiting example, motion detection is often used to detect intruders in vacated homes or buildings, wherein the detection of an intruder may lead to an audio or silent alarm and contact of security personnel. Video monitoring is also used to provide additional information about personnel living in, for a non-limiting example, an assisted living facility.

Currently, home or office security monitoring systems can be artificial intelligence (AI) or machine learning (ML)-driven, which process video and/or audio stream collected from the video cameras and/or other sensors to differentiate and detect abnormal activities/events by persons from their normal daily routines at a monitored location. However, since the video streams often include images and representations of the persons at the monitored location, which may be in private settings, such as inside of their homes and/or offices, such video stream-based security monitoring system may cause privacy concerns with respect to the persons' images and activities in private.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support user privacy protection for security monitoring in accordance with some embodiments.

FIG. 2 depicts an example of how user information is transmitted in accordance with some embodiments.

FIG. 3 depicts an example of a stick figure representing a user/person's body sitting on a bed in his/her bedroom, wherein the stick figure comprises a set of extracted joints and sticks connecting the joints of the person in accordance with some embodiments.

FIGS. 4A-B depict an example of exacting multiple stick figures in a still image from a video stream in accordance with some embodiments.

FIG. 5 depicts an example of an image where a user's body is pixelized by applying a layer of privacy blocks to potential sensitive areas in the image that may be taken in a private setting in accordance with some embodiments.

FIGS. 6A-D depicts an example of pixelizing a portion of human body of a user while uncovering the head portion of the user for identification in accordance with some embodiments.

FIG. 7 depicts a flowchart of an example of a process to support user privacy protection for security monitoring in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support efficient user privacy protection for security monitoring. Under the proposed approach, a privacy mode is deployed to a security monitoring system, which captures privacy information of a user (person being monitored), including but not limited to video, audio, and other privacy information of a user captured during security monitoring. Under the privacy mode, a set of stick figures/skeletons depicting/representing postures of the human body of the user is extracted from a set of still images in a captured video stream. In some embodiments, at least a portion of the human body of the user is pixelized to ensure protection of the user's privacy data while still enabling the security monitoring system to effectively perform its security monitoring functions. In addition, the captured privacy data of the user is securely stored at a local site (e.g., a local database) and boundaries of the user in the images are computed to not only reduce latency of user data processing in real time security monitoring but also to further ensure privacy of the user.

Under the proposed approach, body images and other privacy data of the user are uniquely handled to provide the highest privacy for the user in a security monitoring environment, e.g., in elderly care facilities, homes, and/or work places (e.g., factories, construction sites, retail shops, offices, public transport etc.) or other private settings where residents, workers or customers' privacy is sensitive and expected to be protected by laws and/or regulations. Specifically, this privacy mode is a novel application deployed for human activity monitoring (specifically in elderly home care) to detect possible abnormalities of the users. In the meantime, the proposed approach is able to ensure that the security monitoring can still perform its monitoring functions accurately in real time while protecting the user's privacy data.

Although security monitoring systems have been used as non-limiting examples to illustrate the proposed approach to efficient user privacy protection, it is appreciated that the same or similar approach can also be applied to efficient privacy protection in other types of AI-driven systems that utilize a user's privacy data.

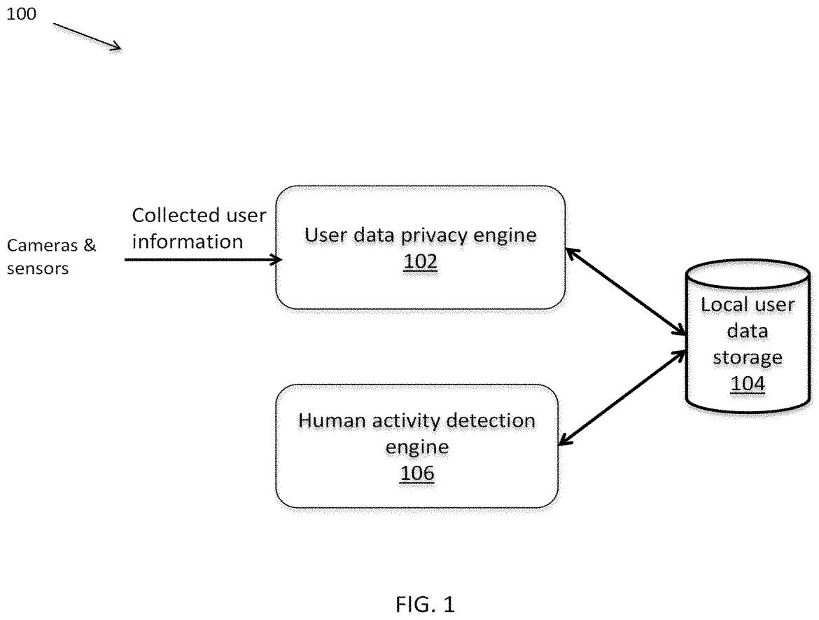

FIG. 1 depicts an example of a system diagram 100 to support user privacy protection for security monitoring. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes one or more of a user data privacy engine 102, a local user data database 104, and a human activity detection engine 106. These components in the system 100 each runs on one or more computing units/appliances/devices/hosts (not shown) each having one or more processors and software instructions stored in a storage unit, such as a non-volatile memory (also referred to as secondary memory) of the computing unit for practicing one or more processes. When the software instructions are executed by the one or more processors, at least a subset of the software instructions is loaded into memory (also referred to as primary memory) by one of the computing units, which becomes a special purposed one for practicing the processes. The processes may also be at least partially embodied in the computing units into which computer program code is loaded and/or executed, such that, the host becomes a special purpose computing unit for practicing the processes.

In the example of FIG. 1, each computing unit can be a computing device, a communication device, a storage device, or any computing device capable of running a software component. For non-limiting examples, a computing device can be but is not limited to a server machine, a laptop PC, a desktop PC, a tablet, a Google's Android device, an iPhone, an iPad, and a voice-controlled speaker or controller. Each computing unit has a communication interface (not shown), which enables the computing units to communicate with each other, the user, and other devices over one or more communication networks following certain communication protocols, such as TCP/IP, http, https, ftp, and sftp protocols. Here, the communication networks can be but are not limited to, Internet, intranet, wide area network (WAN), local area network (LAN), wireless network, Bluetooth, WiFi, and mobile communication network. The physical connections of the network and the communication protocols are well known to those of skilled in the art.

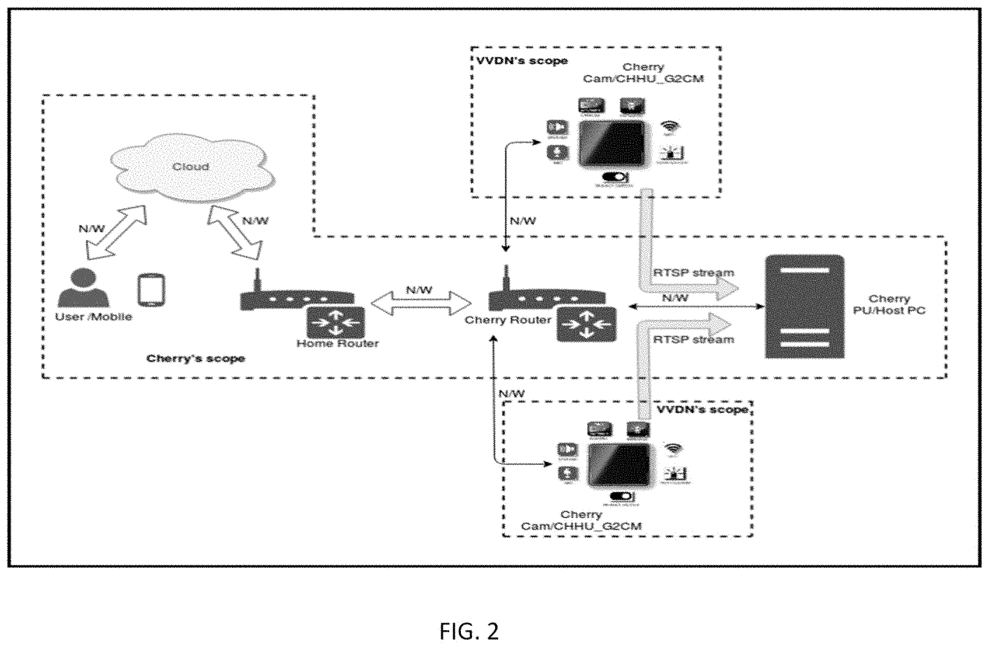

In the example of FIG. 1, the user data privacy engine 102 is configured to accept information of a user including video, audio streams and other data of the user collected by one or more cameras and/or sensors at a monitored location and transmitted to the user data privacy engine 102 via wireless or ethernet connection under a communication protocol, such as Real Time Streaming Protocol (RTSP), which is a network control protocol designed for use to control streaming media. FIG. 2 depicts an example of how the user information is transmitted to the user data privacy engine 102 via, for non-limiting examples, wireless or ethernet connection to router, network and/or cloud. The user data privacy engine 102 is either located at the location monitored by the security monitoring system 100 or remotely at a different location. In some embodiments, the frame rate (frames per second) of the video stream is reduced in order to extract a set of still images from the video stream. In some embodiments, the audio/sound data is separated from the video stream for analysis of the user's activities independent of the video stream. In some embodiments, a batch/set of still images is taken/collected from the collected video stream over a time period (e.g., 6-seconds period), wherein the user data privacy engine 102 remembers the timestamp for this batch and assigns a unique identity for the images from this batch.

In some embodiments, the collected privacy or sensitive information (e.g., images, video, and/or audio) of the users are maintained in a secured local user data database 104, which can be a data cache associated with the user data privacy engine 102, to ensure privacy of the user. For example, live video stream from the cameras can be stored locally as a video archive file. The data locally maintained in the local user data database 104 can be accessed by user data privacy engine 102 and/or the human activity detection engine 106 via one or more Application Programming Interface (API) under strict data access control policies (e.g., only accessible for authorized personnel or devices only) to protect the user's privacy. In some embodiments, information retrieved from the local user data database 104 is encrypted before such information is transmitted over a network for processing. The local user data database 104 guarantees the user being monitored at the location have full control of his/her data, which is particularly important in sensitive or private areas such as a bathroom or a bedroom.

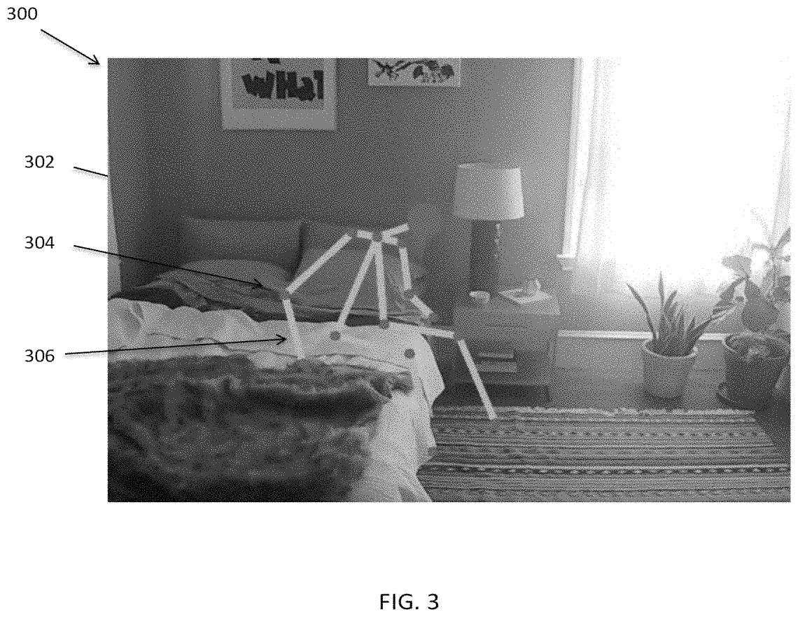

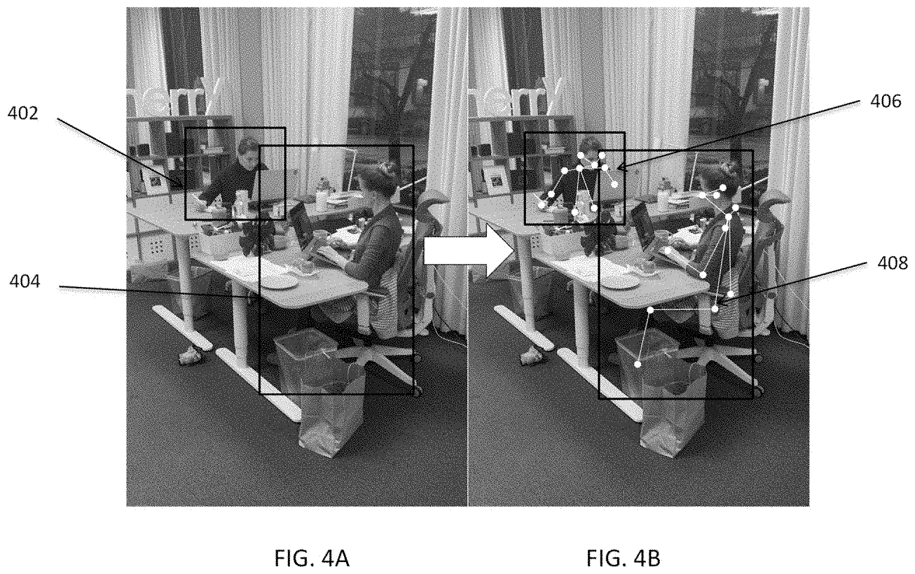

In the example of FIG. 1, the security monitoring system 100 adopts a two-step approach to convert the incoming video stream to the stick figures of a user and to recognize the activities of the user over time. In the first step, the user data privacy engine 102 is configured to adopt a “few shot learning” model by extracting one or more stick figures or skeletons that represent posture of the user's body from the collected data of the user, e.g., a set of one or more still images from the video stream collected at the monitored location, for machine learning and analysis use. In some embodiments, the user data privacy engine 102 is configured to extract a stick figure from a still image by understanding/identifying where the human body of the user is located. In some embodiments, the user data privacy engine 102 is configured to extract boundaries of the human body of the user by computing edges in the one or more still images under the few shot learning model. In some embodiments, the user data privacy engine 102 is configured to utilize a convolutional neural network (CNN) trained with a large dataset (e.g., one million) of human body images and optimized for computing edges to extract the boundaries of the human body of the user. After obtaining the human body boundaries, the user data privacy engine 102 is configured to extract the stick figure of the human body of the user within the boundaries of the human body. FIG. 3 depicts an example of a stick FIG. 302 representing a user/person's body sitting on a bed in his/her bedroom, wherein the stick figure comprises a set of extracted joints 304s and sticks 306s connecting the joints 304s of the user. In some embodiments, the user data privacy engine 102 is configured to utilize a CNN to identify where key points (e.g., joints 304s) of the human body are and in which direction to join the key points into various body segments or sticks 306s. The outcome of this first step is a batch of one or more stick FIGS. 302s in the still image 300. The stick FIG. 302 representing the user's body may then be applied to the train ML models used to detect the user's activities by the human activity detection engine 106 discussed below. Although the stick FIG. 302 represents the user's posture, other information of the user, including but not limited to age, gender, facial expression, and/or a specific private activity/event that the user is involved in, are not observable from the stick FIG. 302 to preserve the user's privacy. FIG. 4A-B depict an example of exacting multiple stick figures in a still image taken from a video stream, wherein locations and boundaries of human bodies of two persons 402 and 404 are respectively identified as shown in FIG. 4A. The corresponding stick figures of the two persons 406 and 408 are then extracted with the boundaries 402 and 404, respectively, as shown in FIG. 4B.

In the next step of the approach, the human activity detection engine 106 is configured to accept and match/compare the stick figure extracted by the user data privacy engine 102 in a still image currently taken from the video stream with a stick figure extracted from an image previously taken from the video stream at the same monitored location to identify or recognize an activity of the user. In some embodiments, the human activity detection engine 106 is located remotely from the user data privacy engine 102 and/or the monitored location. In some embodiments, the human activity detection engine 106 is configured to retrieve the stick figures extracted from the current and/or the previous image of the user from the local user database 104. In some embodiments, the human activity detection engine 106 is configured to determine the probability that the stick figure from current image matches the stick figure from the previous image by calculating one or more of the following metrics between the two stick figures:
proximity by square;
proximity of a 2.5D cumulative motion vector, which is a 2D motion vector with additional information about a person moving in front of a camera, wherein the additional information can be but is not limited to left-to-right vector of movement of the person;
proximity of a 3D position motion vector;
probability of facial and/or body recognition.
   The outcome from this step is a set of stick figures of the same user taken from the video stream in frames and over a period of time.

In some embodiments, the human activity detection engine 106 is configured to track and analyze activity, behavior and/or movement of the user based on the set of stick figures of the user identified over time. If the human activity detection engine 106 determines that the most recent activity of the user as represented by the latest set of stick figures deviates from the user's activity at the same or similar monitored location in the past, the human activity detection engine 106 is configured to identify the most recent activity of the user as abnormal and to alert an administrator at the monitored location about the recognized abnormal activity. In some embodiments, the human activity detection engine 106 is configured to request or subscribe information of the user from the local user database 104 and/or the user data privacy engine 102 directly for tracking and analyzing the activity of the user, wherein the requested or subscribed information include but is not limited to video and/or audio stream, still images from the video stream, and stick figures created from the still images. Since the human activity detection engine 106 is configured to train the ML models and to detect human activities by interpreting the stick figures representing the human body of the user, neither the performance nor functionality of the security monitoring system 100 is compromised by the stick figures whilst providing the privacy features.

In some cases, the camera generating the video stream may be switched to “private mode,” which triggers and records the video stream in private mode, wherein live video stream is not recorded or shared to the security monitoring system 100. Under such private mode, the user data privacy engine 102 is configured to continue to track the stick figures in the video stream. However, the user data privacy engine 102 takes the last free datapoint of a background image of the monitored location instead of the real image from the actual video stream. The user data privacy engine 102 then draws a stick figure in a specific place and time on top of the background image, and uses different color variations of the stick figures to track and monitor the user at the monitored location. The result is a set of color-coded private mode images that represent the user in the video stream.

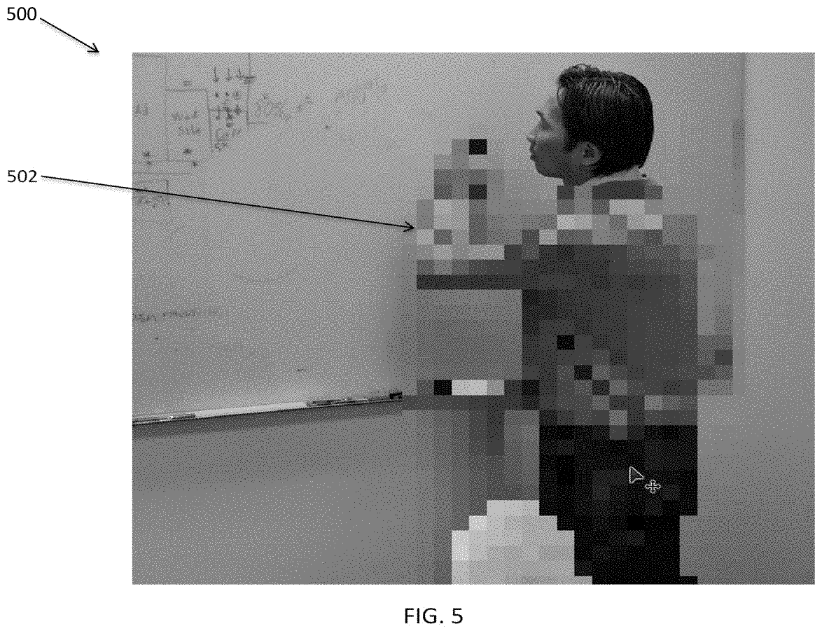

In some embodiments, the user data privacy engine 102 is configured to pixelize the human body of the user in the set of still images taken from the video stream by blurring (e.g., by applying blocks or mosaics over) at least a portion of the human body of the user in the still images frame by frame (e.g., one still image at a time) to further protect the user's privacy and/or identity. Note that the size of blocks for pixelization can be varied. FIG. 5 depicts an example of an image 500 where a user's body 502 is pixelized by applying a layer of privacy blocks each of 50×50 pixels in size to potential sensitive areas in the image 500 that may be taken in a private setting. By pixelizing the human body of the user, the user data privacy engine 102 is configured to transform the video stream where one (e.g., an administrator of the security monitoring system 100) can see all of the private details or sensitive areas of the user's body and clothing to a non-intrusive privacy-protected video stream where the sensitive areas of the user's body and clothing are hidden from the sight of the administrator. In the meantime, part of the human body (e.g., the user's face) is still shown after pixelization for identification of the user at the monitored location while preserving the user's privacy.

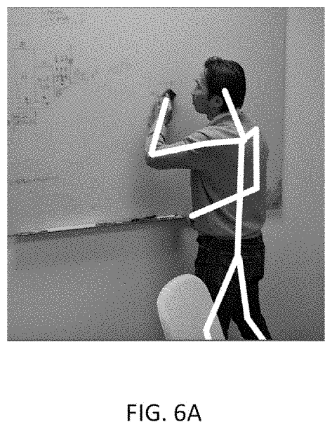

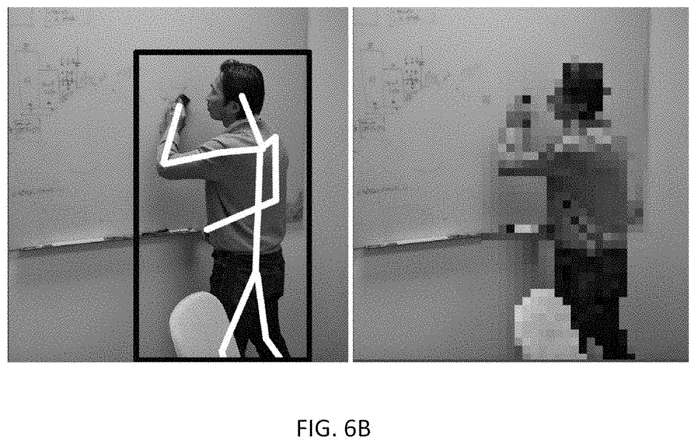

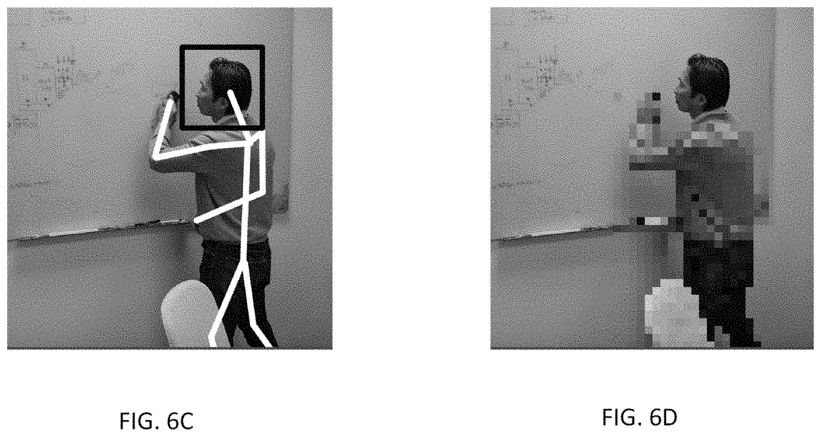

In some embodiments, the user data privacy engine 102 is configured to transform one frame from the video stream for pixelization as follows. First, as shown by the example of FIG. 6A, the user data privacy engine 102 takes an image/frame from the video stream and conducts human pose estimation to obtain a location of the human body as well as a stick figure of the user in the image as discussed above. The user data privacy engine 102 then runs pixelization within a bounding box/boundaries surrounding the stick figure of the user as shown by the example of the pixelized image in FIG. 6B. In some embodiments, the user data privacy engine 102 is configured to crop a portion of human body (e.g., head snapshot) from the original non-pixelized image based on the position of head and shoulders of the user as shown by the example of FIG. 6C. The user data privacy engine 102 then position/paste the cropped portion of the human body on top of corresponding portion of the pixelized human body of the user in order to be able to recognize the identity of the user as shown by the example of FIG. 6D.

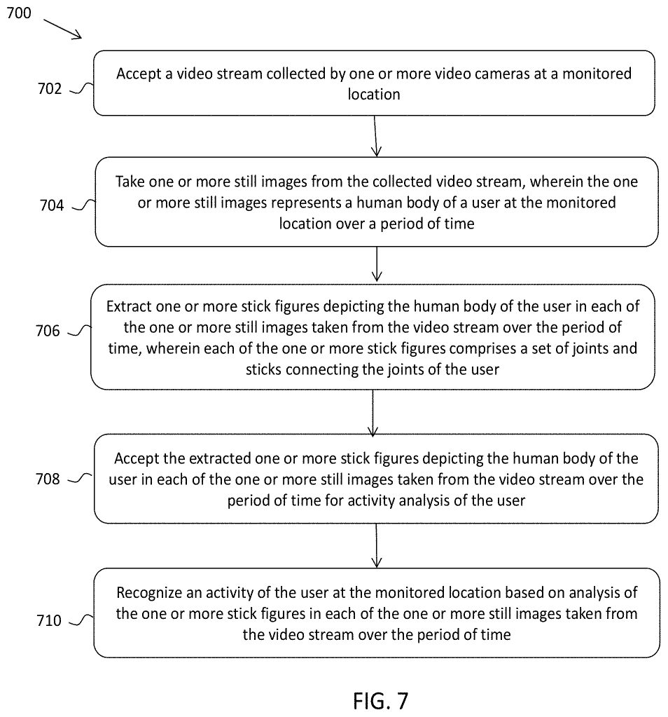

FIG. 7 depicts a flowchart 700 of an example of a process to support user privacy protection for security monitoring. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 7, the flowchart 700 starts at block 702, where a video stream collected by one or more video cameras at a monitored location is accepted. The flowchart 700 continues to block 704, where one or more still images are taken from the collected video stream, wherein the one or more still images represent a human body of a user at the monitored location over a period of time. The flowchart 700 continues to block 706, where one or more stick figures depicting the human body of the user are extracted in each of the one or more still images taken from the video stream over the period of time, wherein each of the one or more stick figures comprises a set of joints and sticks connecting the joints of the user. The flowchart 700 continues to block 708, where the extracted one or more stick figures depicting the human body of the user in each of the one or more still images taken from the video stream over the period of time are accepted for activity analysis of the user. The flowchart 700 ends at block 710, where an activity of the user at the monitored location is recognized based on analysis of the one or more stick figures in each of the one or more still images taken from the video stream over the period of time.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

What is claimed is:

1. A method to support privacy protection for security monitoring, comprising:
accepting a video stream collected by one or more video cameras at a monitored location;
taking one or more still images from the collected video stream, wherein the one or more still images represent a human body of a user at the monitored location over a period of time;
extracting one or more stick figures depicting the human body of the user in each of the one or more still images taken from the video stream over the period of time, wherein each of the one or more stick figures comprises a set of joints and sticks connecting the joints of the user;
accepting the extracted one or more stick figures depicting the human body of the user in each of the one or more still images taken from the video stream over the period of time for activity analysis of the user; and
recognizing an activity of the user at the monitored location based on analysis of the one or more stick figures in each of the one or more still images taken from the video stream over the period of time.

2. The method of claim 1, further comprising:
reducing a frame rate of the video stream in order to extract the set of still images from the video stream.

3. The method of claim 1, further comprising:
separating audio/sound data from the video stream for analysis of the user's activities independent of the video stream.

4. The method of claim 1, further comprising:
maintaining collected sensitive or privacy information of the user in a secured local user data database, which is accessible under data access control policies.

5. The method of claim 1, further comprising:
extracting boundaries of the human body of the user by computing edges in the one or more still images.

6. The method of claim 1, further comprising:
extracting boundaries of the human body of the user via a convolutional neural network (CNN) trained with human body images.

7. The method of claim 1, further comprising:
extracting the one or more stick figures from the one or more still images based on location of the human body of the user in the one or more images.

8. The method of claim 1, further comprising:
recognizing the activity of the user by comparing the one or more stick figures extracted in a still image currently taken from the video stream with one or more stick figures extracted from a still image previously taken from the video stream at the same monitored location.

9. The method of claim 1, further comprising:
identifying the recognized activity of the user as abnormal if the recognized activity deviates from the user's activity at the same or similar monitored location in the past and to alert an administrator at the monitored location about the abnormal activity.

10. The method of claim 1, further comprising:
pixelizing the human body of the user in the one or more still images taken from the video stream by applying blocks over at least a portion of the human body of the user in the one or more still images frame by frame.

11. The method of claim 10, further comprising:
conducting human pose estimation to obtain a location of the human body as well as a stick figure of the user; and
pixelizing within a bounding box surrounding the stick figure of the user.

12. The method of claim 10, further comprising:
cropping a portion of human body of the user from the original non-pixelized image based on the position of head and shoulders of the user; and
pasting the cropped portion of the human body on top of corresponding portion of the pixelized human body of the user in order to be able to recognize the identity of the user.

13. A system to support privacy protection for security monitoring, comprising:
a user data privacy engine configured to
accept a video stream collected by one or more video cameras at a monitored location;
take one or more still images from the collected video stream, wherein the one or more still images represents a human body of a user at the monitored location over a period of time;
extract one or more stick figures depicting the human body of the user in each of the one or more still images taken from the video stream over the period of time, wherein each of the one or more stick figures comprises a set of joints and sticks connecting the joints of the user;
a human activity detection engine configured to accept the extracted one or more stick figures depicting the human body of the user in each of the one or more still images taken from the video stream over the period of time for activity analysis of the user;
recognize an activity of the user at the monitored location based on analysis of the one or more stick figures in each of the one or more still images taken from the video stream over the period of time.

14. The system of claim 13, further comprising:
a local user data database configured to securely maintain collected sensitive or privacy information of the user, wherein the local user data database is accessible under data access control policies.

15. The system of claim 13, wherein:
the user data privacy engine is configured to extract boundaries of the human body of the user by computing edges in the one or more still images.

16. The system of claim 13, wherein:
the user data privacy engine is configured to extract boundaries of the human body of the user via a convolutional neural network (CNN) trained with human body images.

17. The system of claim 13, wherein:
the user data privacy engine is configured to extract the one or more stick figures from the one or more still images based on location the human body of the user in the one or more images.

18. The system of claim 13, wherein:
the human activity detection engine is configured to recognize the activity of the user by comparing the one or more stick figures extracted in a still image currently taken from the video stream with one or more stick figures extracted from a still image previously taken from the video stream at the same monitored location.

19. The system of claim 13, wherein:
the human activity detection engine is configured to identify the recognized activity of the user as abnormal if the recognized activity deviates from the user's activity at the same or similar monitored location in the past and to alert an administrator at the monitored location about the abnormal activity.

20. The system of claim 13, wherein:
the user data privacy engine is configured to pixelize the human body of the user in the one or more still images taken from the video stream by applying blocks over at least a portion of the human body of the user in the one or more still images frame by frame.

21. The system of claim 20, wherein:
the user data privacy engine is configured to
conduct human pose estimation to obtain a location of the human body as well as a stick figure of the user;
pixelize within a bounding box surrounding the stick figure of the user.

22. The system of claim 20, wherein:
the user data privacy engine is configured to
crop a portion of human body of the user from the original non-pixelized image based on the position of head and shoulders of the user;
paste the cropped portion of the human body on top of corresponding portion of the pixelized human body of the user in order to be able to recognize the identity of the user.
